(19) United States
(12) Patent Application Publication
(10) Pub. No.: US 2020/0202510 A1
(43) Pub. Date: Jun. 25, 2020

(54) SPECKLE DETECTION METHOD, SYSTEM, STORAGE MEDIUM, AND COMPUTER PROGRAM PRODUCT

(71) Applicant: SZ DJI TECHNOLOGY CO., LTD., Shenzhen (CN)

(72) Inventors: Hualiang Feng, Shenzhen (CN); Jiexi Du, Shenzhen (CN)

(21) Appl. No.: 16/803,022

(22) Filed: Feb. 27, 2020

Related U.S. Application Data
(63) Continuation of application No. PCT/CN2017/099978, filed on Aug. 31, 2017.

(51) Int. Cl. G06T 7/00; G06T 3/40; G06K 9/60; G06T 7/60

(52) U.S. Cl. CPC G06T 7/0002; G06T 3/4023; G06T 2207/20024; G06T 7/60; G06T 2207/20021; G06K 9/60

(57) ABSTRACT

Speckle detection method, system, storage medium and computer program product are provided. The speckle detection method includes acquiring a thumbnail image of a to-be-processed image; performing a speckle detection on the thumbnail image to obtain speckled pixels of the thumbnail image; and determining, according to the speckled pixels of the thumbnail image, speckled pixels of the to-be-processed image.

### CROSS-REFERENCES TO RELATED APPLICATIONS

This application claims priority of International Patent Application No. PCT/CN2017/099978, filed on Aug. 31, 2017, the entire contents of which are hereby incorporated by reference.

### COPYRIGHT NOTICE

A portion of the present disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The present disclosure generally relates to the field of image processing and, more particularly, relates to a speckle detection method, a system, a storage medium, and a computer program product.

### BACKGROUND

Speckles (or speckle noise) in an image may affect the quality of the image. Therefore, in order to improve the image quality, a speckle detection and a speckle filtering in the image are often required.

A traditional image speckle detection method traverses each pixel of a to-be-processed image, and directly performs a speckle detection on the to-be-processed image. However, the size of the to-be-processed image is generally large. Directly performing the speckle detection on the to-be-processed image may result in a low efficiency of the image speckle detection.

In order to improve the efficiency of the image speckle detection, a speckle detection method, a system, a storage medium, and a computer program product are provided in the present disclosure.

### BRIEF SUMMARY OF THE DISCLOSURE

One aspect of the present disclosure provides a speckle detection method. The method includes: acquiring a thumbnail image of a to-be-processed image; performing a speckle detection on the thumbnail image to obtain speckled pixels of the thumbnail image; and determining, according to the speckled pixels of the thumbnail image, speckled pixel of the to-be-processed image.

Another aspect of the present disclosure provides an image processing system. The system includes a memory for storing programs and a processor for executing the programs stored in the memory. When programs are executed, the processor is configured to execute: acquiring a thumbnail image of a to-be-processed image; performing a speckle detection on the thumbnail image to obtain speckled pixels of the thumbnail image; and determining, according to the speckled pixels of the thumbnail image, speckled pixel of the to-be-processed image.

Another aspect of the present disclosure provides a non-transitory computer-readable storage medium, containing program instructions for a computer, when the program instructions being executed, to perform a method. The method includes: acquiring a thumbnail image of a to-be-processed image; performing a speckle detection on the thumbnail image to obtain speckled pixels of the thumbnail image; and determining, according to the speckled pixels of the thumbnail image, speckled pixels of the to-be-processed image.

Other aspects or embodiments of the present disclosure can be understood by those skilled in the art in light of the description, the claims, and the drawings of the present disclosure.

### BRIEF DESCRIPTION OF THE DRAWINGS

FIG. 1 illustrates a schematic flowchart of a speckle detection method consistent with various disclosed embodiments of the present disclosure;

FIG. 2 illustrates a schematic flowchart of an implementation of an exemplary step 130 in FIG. 1 consistent with various disclosed embodiments of the present disclosure;

FIG. 3 illustrates a schematic flowchart of another implementation of an exemplary step 130 in FIG. 1 consistent with various disclosed embodiments of the present disclosure;

FIG. 4 illustrates an exemplary diagram of an implementation of selecting reference pixels of first pixels by using a distance relationship between pixels as a standard consistent with various disclosed embodiments of the present disclosure;

FIG. 5 illustrates an exemplary diagram of an implementation of selecting reference pixels of first pixels by using an adjacent relationship between pixels as a standard consistent with various disclosed embodiments of the present disclosure;

FIG. 6 illustrates a schematic flowchart of an implementation of an exemplary step 320 in FIG. 3 consistent with various disclosed embodiments of the present disclosure; and

FIG. 7 illustrates a schematic diagram of an image processing system consistent with various disclosed embodiments of the present disclosure.

### DETAILED DESCRIPTION

The present disclosure may be applied to various image processing systems that need to perform a speckle detection and/or a speckle filtering on an image. An image processing system may be a system with a visual perception function, such as a unmanned aerial vehicle, a robot, a self-driving car, a submersible, etc.

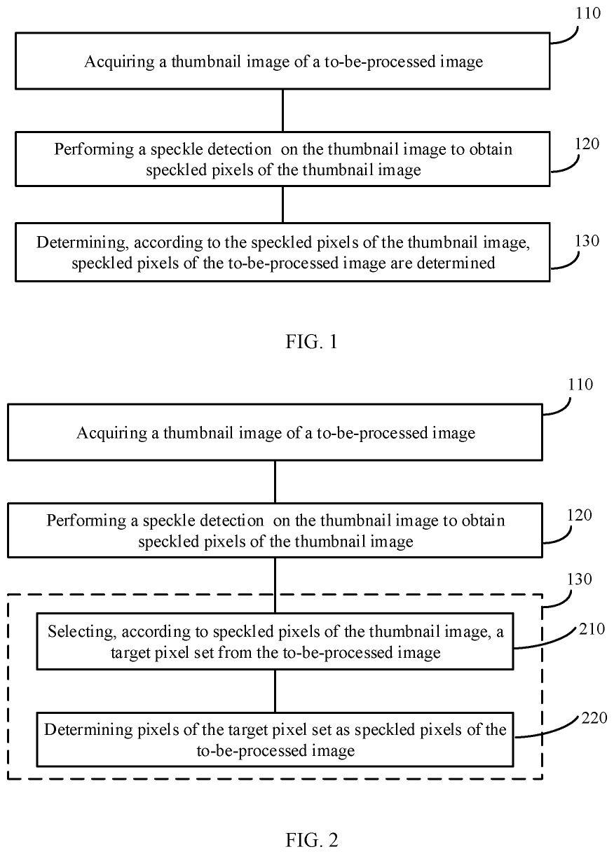

In one embodiment, a speckle detection method, which can improve a speckle detection efficiency of an image, is described in detail in the following with reference to FIG. 1.

FIG. 1 illustrates a schematic flowchart of a speckle detection method consistent with various disclosed embodiments of the present disclosure. The method may be performed by the processing systems described above. For example, the method may be performed by a processing unit in an image processing system. The processing unit may be at least one of the following processing units: a central processing unit (CPU), a digital signal processor (DSP), or an intellectual property (IP) core. The method may include exemplary steps 110-130 described in detail in the following.

In step 110, a thumbnail image of a to-be-processed image is acquired. The thumbnail image of the to-be-processed image can also be referred to as a small image of the to-be-processed image. The thumbnail image and the to-be-processed image depict a same object. A difference between the thumbnail image and the to-be-processed image is that a resolution of the thumbnail image is smaller than a resolution of the to-be-processed image. For example, the resolution of the thumbnail image is 256×256, and the resolution of the to-be-processed image is 1024×1024.

Manners of acquiring thumbnail images are not specifically limited herein. As an example, a to-be-processed image may be down-sampled to obtain a thumbnail image. As another example, the to-be-processed image may be sampled to obtain a thumbnail image. That is, a thumbnail image can be a down-sampled image or a sampled image of a to-be-processed image. Pixels of the sampled image can be composed of part of pixels of the to-be-processed image (that is, pixels of the to-be-processed image as sampling points).

In step 120, a speckle detection is performed on the thumbnail image to obtain speckled pixels of the thumbnail image. A speckle detection method of the thumbnail image is not specifically limited herein. Any speckle detection algorithm may be applied to perform the speckle detection on the thumbnail image. For example, in a speckle detection algorithm based on connected domains, a pixel value of each pixel of the thumbnail image can be detected first. If pixel values of pixels with a connected-relationship in the thumbnail image are close (for example, differences between the pixel values are less than a preset difference), areas where pixels with an adjacent-relationship are located are called connected domains. Accordingly, areas of the connected domains in the thumbnail image can be determined. If the areas of the connected domains are less than a preset threshold, all pixels of the connected domain are considered speckled pixels.

In some embodiments, speckled pixels of the thumbnail image may refer to pixels of a speckled area in the thumbnail image. Or, the speckled pixels of the thumbnail image may refer to pixels of the thumbnail image that are determined to be speckles or speckle noise.

In step 130, according to the speckled pixels of the thumbnail image, speckled pixels of the to-be-processed image are determined. There are various implementations of step 130, which are not specifically limited herein. For example, pixels of the to-be-processed image corresponding to the speckled pixels of the thumbnail image can be directly determined as speckled pixels of the to-be-processed image. For another example, according to pixel values of pixels corresponding to the speckled pixels of the thumbnail image and its surrounding pixels of the to-be-processed image, speckled pixels of the to-be-processed image may be determined. The implementation is described in detail in combination with a specific embodiment in the following.

Compared with the to-be-processed image, a size of the thumbnail image is smaller. Correspondingly, a speckle detection process of the thumbnail image is more efficient. Further, by using speckle detection results of the thumbnail image, determining the speckled pixels of the to-be-processed image is equivalent to performing a speckle detection on the to-be-processed image in the condition of knowing an approximate area of the speckled pixels of the to-be-processed image. An overall speckle detection efficiency of the to-be-processed image may be improved.

In an existing image speckle detection method based on connected domains, a random access to an entire image data of the to-be-processed image is required due to an uncertainty of shapes of the connected domains of the image. The shapes can be expanded in any direction of the image. An image processing system may perform an efficient random access to the image data in memory. However, a memory capacity of the image processing system (especially an on-chip image processing system) is generally small, and the entire image data cannot be accommodated at one time. Accordingly, the image processing system needs to store the entire image in an external memory and randomly accesses the image data in the external memory. The image processing system has a low efficiency of the random access to the external memory, resulting in a low efficiency of a traditional image speckle detection method.

Optionally, in one embodiment, a size of the image data of the thumbnail image may be set to be smaller than a capacity of a memory (the capacity of the memory may refer to a total capacity of the memory or a capacity of a current free space of the memory). Before step 120, a speckle detection method shown in FIG. 1 may further include: reading the image data of the thumbnail image from an external memory into a memory (one-time reading into the memory). Step 120 may include: performing a speckle detection on the thumbnail image in the memory. Assuming that a ratio of sampling (or down-sampling) of the thumbnail image is 1/M, the memory space required for the speckle detection of the thumbnail image is 1/(M*M). Compared with the to-be-processed image, the thumbnail image requires a less memory. Because the thumbnail image is small and can be read into the memory at one time, the image processing system does not need to randomly access an external storage device, which will greatly improve the speckle detection efficiency of the image.

Optionally, in one embodiment, a size of the image data of the thumbnail image may be set to be smaller than a capacity of a memory (the capacity of the memory may refer to a total capacity of the memory or a capacity of a current free space of the memory). Step 110 may include: performing a speckle detection on the thumbnail image in the memory. Assuming that a ratio of sampling (or down-sampling) of the thumbnail image is 1/M, the memory space required for the speckle detection of the thumbnail image is 1/(M*M). Further, because the thumbnail image is small and can be read into the memory at one time, the image processing system does not need to randomly access an external storage device, which will greatly improve the speckle detection efficiency of the image.

A specific implementation of step 130 is described in detail in the following with reference to FIGS. 2 to 6.

FIG. 2 illustrates a schematic flowchart of an implementation of step 130 in FIG. 1 consistent with various disclosed embodiments of the present disclosure. In a corresponding implementation shown in FIG. 2, pixels of a thumbnail image are part of pixels of a to-be-processed image, that is, the pixels of the thumbnail image may be composed of part of the pixels of the to-be-processed image. For example, the thumbnail image may be a sample image of the to-be-processed image. The method shown in FIG. 2 may include exemplary steps 210 and 220, which are described in detail in the following.

In step 210, according to speckled pixels of the thumbnail image, a target pixel set is selected from the to-be-processed image.

In step 220, pixels of the target pixel set are determined as speckled pixels of the to-be-processed image.

Pixels of the target pixel set may be pixels having a corresponding relationship with the speckled pixels of the thumbnail image. The corresponding relationship may refer to: after the thumbnail image is enlarged to be equal to a size of the to-be-processed image, a relative position of the pixels of the target pixel set in the to-be-processed image is the same as a relative position of speckled pixels of the thumbnail image. In some embodiments, the thumbnail image is composed of part of pixels of the to-be-processed image. The pixels of the target pixel set may be same pixels as speckled pixels of the thumbnail image. In one embodiment, the same pixels of the to-be-processed image as speckled pixels of the thumbnail image are directly determined as speckled pixels of the to-be-processed image.

For example, assuming the to-be-processed image includes pixels {p0, p1, p2, p3, p4, p5, p6, p7, p8}, the thumbnail image includes pixels {p0, p3, p6}, and assuming that after step 210, the pixels {p3, p6} of the thumbnail image are determined as speckled pixels, the pixels {p3, p6} of the to-be-processed image constitute a target pixel set of the to-be-processed image. In a corresponding implementation shown in FIG. 2, the pixels {p3, p6} of the to-be-processed image will be directly determined as speckled pixels of the to-be-processed image.

The pixels of the thumbnail image consist of part of the pixels of the to-be-processed image. If a pixel of the thumbnail image is determined to be a speckled pixel, there is a high probability that a same pixel of the to-be-processed image is also a speckled pixel. A corresponding implementation in FIG. 2 makes full use of a pixel relationship between the thumbnail image and the to-be-processed image. The pixels of the to-be-processed image that are the same as the speckled pixels of the thumbnail image are directly determined as the speckled pixels of the image to be processed, which simplifies the speckle detection method of the to-be-processed image.

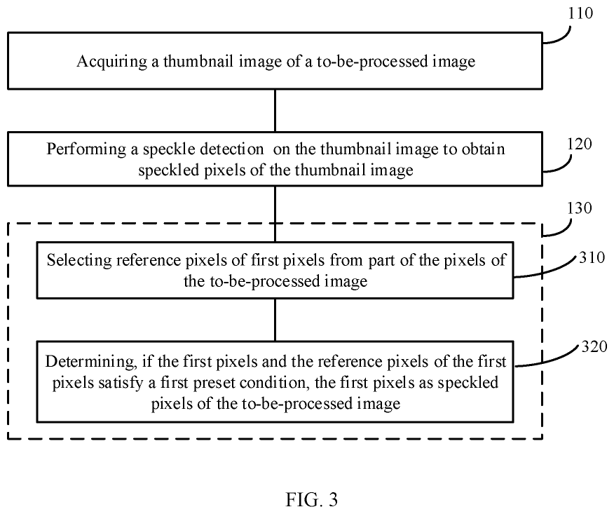

FIG. 3 illustrates a schematic flowchart of another implementation of step 130 in FIG. 1 consistent with various disclosed embodiments of the present disclosure. In a corresponding implementation shown in FIG. 3, pixels of a thumbnail image are part of pixels of the to-be-processed image, that is, the pixels of the thumbnail image may be composed of part of the pixels of the to-be-processed image. For example, the thumbnail image may be a sample image of the to-be-processed image. The method shown in FIG. 3 may include exemplary steps 310 and 320 which are described in detail in the following.

A first pixel in FIG. 3 may be any pixel of remaining pixels of the to-be-processed image except a target pixel set (definition of a target pixel set is the same as the definition of the target pixel set in FIG. 2, a specific description may refer to the related description in FIG. 2). A pixel set formed by the remaining pixels of the to-be-processed image except the target pixel set is hereinafter referred to as a second pixel set of the to-be-processed image. The first pixel is any pixel of the second pixel set of the to-be-processed image.

Optionally, in some embodiments, each pixel in the second pixel set of the to-be-processed image may be used as a first pixel to perform once a process shown in FIG. 3. Optionally, in other embodiments, only part of pixels of the second pixel set of the to-be-processed image may be used as first pixels to perform the process shown in FIG. 3. For example, in some applications, users are not concerned about whether speckled pixels appear in an edge area of the to-be-processed image. Accordingly, the process shown in FIG. 3 can be performed without using pixels in the second pixel set of the to-be-processed image located in the edge area of the to-be-processed image as first pixels.

In step 310, reference pixels of first pixels are selected from part of the pixels of the to-be-processed image. Reference pixels may be pixels adjacent to a first pixel among part of the pixels of the to-be-processed image, or one or more pixels closest to the first pixel among part of the pixels of the to-be-processed image.

Part of the pixels of the to-be-processed image in step 310 refer to the pixels of the to-be-processed image that are used to form the thumbnail image. For ease of description, part of the pixels of the to-be-processed image are hereinafter referred to as first type pixels of the to-be-processed image. The remaining pixels of the to-be-processed image except the first type pixels are referred to as second type pixels of the to-be-processed image.

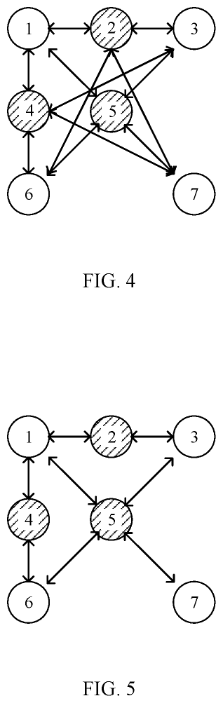

There is a plurality of ways to select reference pixels of a first pixel. For example, the reference pixels of the first pixel may be selected by using a distance relationship between pixels as a standard in a to-be-processed image. As another example, the reference pixels of the first pixel may be selected based on an adjacent relationship between pixels of the to-be-processed image. Two possible selection methods of the reference pixel of the first pixel are given in the following with reference to FIG. 4 and FIG. 5.

FIG. 4 illustrates an exemplary diagram of an implementation of selecting reference pixels of first pixels by using a distance relationship between pixels as a standard consistent with various disclosed embodiments of the present disclosure. Referring to FIG. 4, pixels 1, 3, 6, and 7 are first type pixels of the to-be-processed image. Pixels 2, 4, and 5 are second type pixels of the to-be-processed image. Assuming that a first pixel is pixel 2 in FIG. 4, based on the distance relationship between the first type pixels of the to-be-processed image and pixel 2, four pixels closest to pixel 2 can be selected from the first type pixels of the to-be-processed image as reference pixels for pixel 2. As can be seen from FIG. 4, the reference pixels of pixel 2 are pixels 1, 3, 6, 7. Similarly, assuming that a first pixel is pixel 4, based on the distance relationship between the first type pixels of the to-be-processed image and pixel 4, four pixels closest to pixel 4 can be selected from the first type pixels of the to-be-processed image as reference pixels of pixel 4. It can be seen from FIG. 4 that the reference pixels of pixel 2 may also be pixels 1, 3, 6, and 7. Similarly, assuming that a first pixel is pixel 5, based on the distance relationship between the first type pixels of the to-be-processed image and pixel 5, four pixels closest to pixel 5 can be selected from the first type pixels of the to-be-processed image as reference pixel for pixel 5. As can be seen from FIG. 4, the reference pixels of pixel 2 may also be pixels 1, 3, 6, and 7.

FIG. 5 illustrates an exemplary diagram of an implementation of selecting reference pixels of first pixels by using an adjacent relationship between pixels as a standard consistent with various disclosed embodiments of the present disclosure. Referring to FIG. 5, pixels 1, 3, 6, and 7 are first type pixels of the to-be-processed image, pixels 2, 4, and 5 are second type pixels of the to-be-processed image. Assuming that a first pixel is pixel 2 in FIG. 4, based on the adjacent relationship between the first type pixels of the to-be-processed image and pixel 2, pixels adjacent to pixel 2 may be selected from the first type pixels of the to-be-processed image as the reference pixels for pixel 2. As shown in FIG. 5, the reference pixels of pixel 2 are pixels 1 and 3. Assuming that a first pixel is pixel 4, based on the adjacent relationship between the first type pixels of the to-be-processed image and pixel 4, pixels adjacent to pixel 4 can be selected from the first type pixels of the to-be-processed image as a reference pixel. As shown in FIG. 5, the reference pixels of pixel 4 are pixels 1,6. Similarly, assuming that a first pixel is pixel 5, based on the adjacent relationship between the first type pixels of the to-be-processed image and pixel 5, pixels adjacent to pixel 5 can be selected from the first type pixels of the to-be-processed image as the reference pixel for pixel 5. As shown in FIG. 5, the reference pixels of pixel 5 are pixels 1, 3, 6, 7.

Number of reference pixels of the first pixel is not specifically limited herein and may be determined by comprehensively considering requirements of accuracy and efficiency of a speckle detection algorithm. In some embodiments, in order to simplify the algorithm, an upper limit of the number of the reference pixels of the first pixel may be set in advance to k. If the number of pixels of the first type pixels of the to-be-processed image that can be used as the reference pixels of the first pixel is greater than k, according to a certain preset rule, k pixels can be selected as the reference pixels from the m pixels. For example, k pixels can be randomly selected from m pixels as the reference pixels of the first pixel.

In step 320, if the first pixels and the reference pixels of the first pixels satisfy a first preset condition, determine the first pixels as speckled pixels of the to-be-processed image.

Accordingly, the disclosed embodiments make full use of a pixel relationship between the thumbnail image and the to-be-processed image to perform a speckle detection on the to-be-processed image, thereby simplifying a speckle detection process of the to-be-processed image. Further, the speckle detection process of the to-be-processed image described in FIG. 3 does not require undirected random access of the entire image of the to-be-processed image, which is simple to implement. In addition, in the implementation corresponding to FIG. 2 and FIG. 3, the determination process of each pixel of the to-be-processed image is independent of each other. Pixels of the to-be-processed image can be continuously accessed. The pixels of the to-be-processed image can be processed in parallel.

A method shown in FIG. 2 and a method shown in FIG. 3 may be implemented independently or may be mutually coupled together. As an example, after the method shown in FIG. 2 is performed, the method shown in FIG. 3 may be continued. Not only the pixels of the target pixel set of the to-be-processed image may be determined as speckled pixels, but the remaining pixels of the to-be-processed image may also be determined as speckled pixels, reducing the probability of missing speckled pixels of the to-be-processed image.

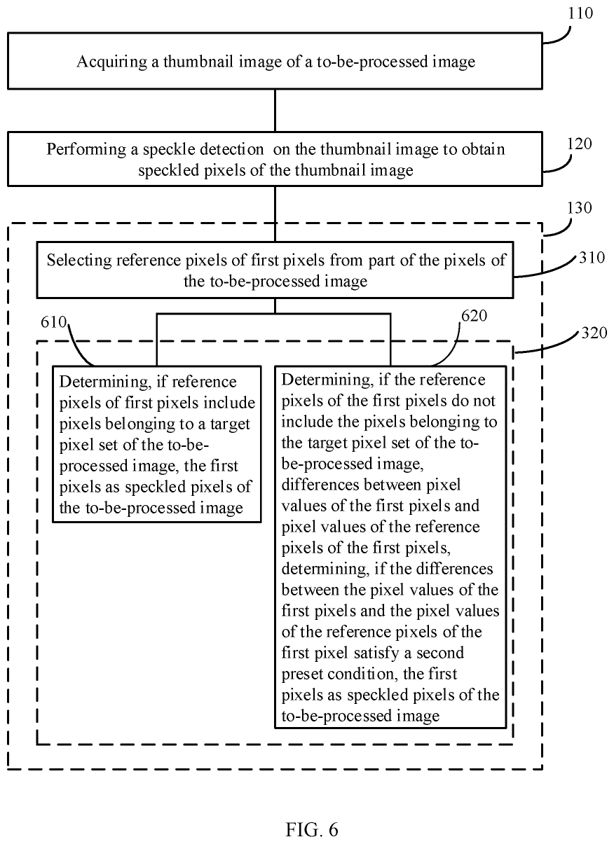

A setting manner of the first preset condition is not specifically limited herein. For example, the setting manner may be determined based on whether reference pixels of a first pixel include pixels in a target pixel set belonging to the to-be-processed image (refer to the above definition of the target pixel set). For another example, the setting manner may be determined based on a relationship between the reference pixels of the first pixel and a pixel value of the first pixel. Or, the setting manner can be a combination of the above two setting methods. The setting methods of the first preset condition are different. Correspondingly implementations of step 320 are different. A specific implementation of step 320 is given in the following with reference to FIG. 6. As shown in FIG. 6, step 320 may include exemplary steps 610 and 620.

In step 610, if reference pixels of first pixels include pixels belonging to a target pixel set of a to-be-processed image, the first pixels are determined as speckled pixels of the to-be-processed image.

If the reference pixels of a first pixel include the pixels belonging to the target pixel set of the to-be-processed image, the first pixel is adjacent to the area where a target pixel set of to-be-processed pixels is located. Compared with other pixels of the to-be-processed image, pixels adjacent to the area where the target pixel set is located are more likely to be speckled pixels. Such pixels can be directly determined as speckled pixels, thereby reducing the probability of missing speckled pixels of the to-be-processed image.

In step 620, if the reference pixels of the first pixels do not include the pixels belonging to the target pixel set of the to-be-processed image, differences between pixel values of the first pixels and pixel values of the reference pixels of the first pixels are determined. If the differences between the pixel values of the first pixels and the pixel values of the reference pixels of the first pixel satisfy a second preset condition, the first pixels are determined as speckled pixels of the to-be-processed image.

As described above, if the reference pixels of a first pixel includes the pixels belonging to a target pixel set of the to-be-processed image, the first pixel is adjacent to the area where the target pixel set of the to-be-processed image is located. Similarly, if the reference pixels of the first pixel do not include the pixels belonging to the target pixel set of the to-be-processed image, the first pixel is not adjacent to the area where the target pixel set of the to-be-processed image is located (at least one pixel is spaced in the middle). For such pixels, one possible determination method is to directly determine such pixels as non-speckled pixels of the to-be-processed image. However, the judgement manner may be missed. In one embodiment, by using a difference between the first pixel and the reference pixels of the first pixel, the possibility that the first pixel is a speckled pixel is further determined. If the difference between the first pixel and the reference pixels of the first pixel satisfies a preset condition, the first pixel is also determined as a speckled pixel, so as to reduce the probability that a speckle pixel of the to-be-processed image is missed.

The determination result obtained in step 620 is related to a setting method of the second preset condition. The setting method of the second preset condition is not specially limited herein and may be set according to actual needs.

As an example, a second preset condition may be: if a difference between the pixel value of the first pixel and a pixel value of any reference pixel of the first pixel is greater than a preset threshold, the first pixel is determined as a speckled pixel of the to-be-processed image. If the difference between the pixel value of the first pixel and the pixel values of the reference pixels is large, the pixel value of the first pixel is abrupt compared with surrounding pixels of the first pixel. A pixel with a sudden change in pixel value is more likely to be a speckled pixel. Determining such a pixel as a speckled pixel can reduce the probability of missed detection of a speckled pixel.

In addition to the above definitions, the second preset condition can also adopt other definitions. For example, the second preset condition may be: if a difference between a pixel value of a first pixel and an average value of reference pixels of the first pixel is greater than a preset threshold, the first pixel is determined as a speckled pixel of the to-be-processed image.

The above description uses FIG. 6 as an example to describe exemplary steps 610 and 620. In some embodiments, FIG. 6 may include step 610 instead of step 620. For example, when it is determined that the reference pixels of the first pixels include pixels belonging to the target pixel set of the to-be-processed image, step 610 is performed, otherwise, no operation is performed. Optionally, in other embodiments, FIG. 6 may also include step 620 instead of step 610. For example, when it is determined that the reference pixels of the first pixels do not include the pixels belonging to the target pixel set of the to-be-processed image, step 620 is performed, otherwise, no operation is performed.

From the embodiments described above, an execution process of step 130 no longer requires a random access to an entire image of the to-be-processed image like a traditional image speckle detection method. In some embodiments, The execution process may continuously access the to-be-processed image, such as reading the pixels of the to-be-processed image into a memory row by row, column by column or block by block, which can simplify an access process of an image data and improve a processing efficiency of the image data. Since a speckle detection process of each pixel of the to-be-processed image is relatively independent, the pixels stored in a memory can be processed in parallel.

As an example, step 130 may include: reading a first image block of a to-be-processed image from an external memory into a memory at one time; selecting a second image block corresponding to the first image block from a thumbnail image, and the second image including pixels of the thumbnail image that are down-sampled or sampled from the first image block; and determining, according to the second image block, speckled pixels of the first image block.

The first image block may be composed of one or more rows of the pixels of the to-be-processed image, or may be composed of one or more columns of the pixels of the to-be-processed image, or may also be composed of a plurality of pixels having an adjacent relationship in an arbitrary image area of the to-be-processed image.

Further, in some embodiments, according to current capacity of the memory, a size of the first image block can be flexibly adjusted.

Further, in some embodiments, the first image block may include a plurality of pixels, and the plurality of pixels may be processed in parallel. Parallel processing of pixels of a to-be-processed image can greatly improve a speckle detection efficiency of the to-be-processed image.

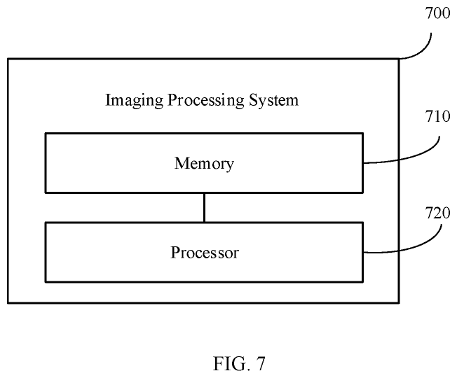

A speckle detection method provided by above embodiments is described in detail with reference to FIGS. 1 to 6. An image processing system provided by one embodiment is described in detail in the following with reference to FIG. 7

FIG. 7 illustrates a schematic diagram of an image processing system consistent with various disclosed embodiments of the present disclosure. An image processing system 700 includes a memory 710 and a processor 720. The memory 710 may be configured to store programs. The processor 720 may be configured to execute programs stored in the memory. When the programs stored in the memory 710 are executed, the processor 720 may be configured to execute a speckle detection method described in any one of above embodiments.

In the above embodiments, a speckle detection method may be implemented in whole or in part by software, hardware, firmware, or any other combination. When implemented by software, the speckle detection method may be implemented in whole or in part in the form of a computer program product. The computer program product includes one or more computer instructions. When the computer program instructions are loaded and executed on a computer, processes or functions according to the embodiments of the present disclosure are wholly or partially generated. The computer may be a general-purpose computer, a special-purpose computer, a computer network, or other programmable device. The computer instructions may be stored in a computer-readable storage medium or transmitted from one computer-readable storage medium to another computer-readable storage medium. For example, the computer instructions may be transmitted from a website site, computer, server, or data center via a wired manner (such as coaxial cable, optical fiber, digital subscriber line (DSL)) or a wireless manner (such as infrared, wireless, microwave, etc.) to another website site, computer, server or data center. The computer-readable storage medium may be any available medium that may be accessed by a computer or a data storage device such as a server, a data center, and the like that includes one or more available medium integrations. The usable medium may be a magnetic medium (such as a floppy disk, a hard disk, a magnetic tape), an optical medium (such as a digital video disc (DVD)), or a semiconductor medium (for example, a solid state disk (SSD)), etc

Those skilled in the art may realize that units and algorithm steps of each example described in connection with embodiments disclosed herein can be implemented by electronic hardware, or a combination of computer software and electronic hardware. Whether these functions are performed by hardware or software depends on the specific application and design constraints of the technical solution. Professionals can use different methods to implement the described functions for each specific application, but this implementation should not be considered beyond the scope of the present disclosure.

In several embodiments provided by the present disclosure, the disclosed apparatus and methods may be implemented in other ways, and the device embodiments described above are merely exemplary. The division of the unit is only a kind of logical function division, and there may be another division manner in actual implementation. For example, multiple units or components can be combined or integrated into another system, or some features can be ignored or not implemented. The displayed or discussed mutual coupling or direct coupling or communication connection may be indirect coupling or communication connection through some interfaces, devices or units, which may be electrical, mechanical or other forms.

The units described as separate components may or may not be physically separated. Parts displayed as units may or may not be physical units. That is, parts can be located in one place or distributed across multiple network elements. According to actual needs, some or all of the units can be selected to achieve the purpose of the solution of one embodiment.

In addition, each functional unit in each embodiment of the present disclosure may be integrated into one processing unit, or each unit may exist separately physically, or two or more units may be integrated into one unit. The above integrated units can be implemented in the form of hardware, or in the form of hardware plus software functional units.

The above are only specific implementations of the present disclosure. The protection scope of the present application is not limited to the specific implementations.

Those skilled in the art can easily think of changes or replacements within the technical scope disclosed in the disclosure, which should be covered by the protection scope of the present disclosure.

What is claimed is:

1. A speckle detection method, comprising:
acquiring a thumbnail image of a to-be-processed image;
performing a speckle detection on the thumbnail image to obtain speckled pixels of the thumbnail image; and
determining, according to the speckled pixels of the thumbnail image, speckled pixels of the to-be-processed image.

2. The method according to claim 1, wherein determining, according to the speckled pixels of the thumbnail image, the speckled pixels of the to-be-processed image comprises:
selecting, according to the speckled pixels of the thumbnail image, a target pixel set from the to-be-processed image, pixels of the target pixel set being pixels having a corresponding relationship with the speckled pixels of the thumbnail image; and
determining the pixels of the target pixel set as the speckled pixels of the to-be-processed image.

3. The method according to claim 1, wherein determining, according to the speckled pixel of the thumbnail image, the speckled pixels of the to-be-processed image comprises:
selecting reference pixels of first pixels from part of pixels of the to-be-processed image, a first pixel being any one of the remaining pixels of the to-be-processed image except the target pixel set, the pixels of the target pixel set being pixels having a corresponding relationship with the speckled pixels of the thumbnail image, the reference pixels are one or more pixels of part of the pixels that are closest to the first pixel; and
determining, if the first pixels and the reference pixels of the first pixel satisfy a first preset condition, the first pixel as the speckled pixels of the to-be-processed image.

4. The method according to claim 3, wherein determining, if the first pixels and the reference pixels of the first pixels satisfy the first preset condition, the first pixels as the speckled pixels of the to-be-processed image comprises:
determining, if the reference pixels of the first pixels include pixels belonging to the target pixel set, the first pixels as the speckled pixels of the to-be-processed image; and
determining, if the reference pixels of the first pixels does not include the pixels belonging to the target pixel set, differences between pixel values of the first pixels and pixel values of the reference pixels of the first pixels; determining, if the differences between the pixel value of the first pixel and pixel values of the reference pixels of the first pixel satisfy a second preset condition, the first pixels as speckled pixels of the to-be-processed image.

5. The method according to claim 4, wherein determining, if the differences between the pixel values of the first pixels and the pixel values of the reference pixels of the first pixel satisfy the second preset condition, the first pixels as the speckled pixels of the to-be-processed image comprises:
determining, if the differences between the pixel values of the first pixel and a pixel value of any one of the reference pixels of the first pixel are greater than a preset threshold, the first pixels as the speckled pixels of the to-be-processed image.

6. The method according to claim 3, wherein the reference pixels of a first pixel are pixels adjacent to the first pixel of the to-be-processed image.

7. The method according to claim 1, wherein determining, according to the speckled pixels of the thumbnail image, the speckled pixels of the to-be-processed image comprises:
selecting adjacent pixels of each pixel in at least one pixel in the target pixel set from the to-be-processed image, the pixels in the target pixel set being pixels having a corresponding relationship with the speckled pixels of the thumbnail image; and
determining the adjacent pixels of each pixel as speckled pixels of the to-be-processed image.

8. The method according to claim 2, wherein the pixels of the thumbnail image are part of pixels of the to-be-processed image, and the pixels in the target pixel set are same pixels as the speckled pixels of the thumbnail image.

9. The method according to claim 1, wherein a size of an image data of the thumbnail image is smaller than a capacity of a memory, and before a speckle detection on the thumbnail image is performed, the method further comprises:
reading the thumbnail image into the memory;
performing a speckle detection on the thumbnail image including:
performing the speckle detection on the thumbnail image in the memory.

10. The method according to claim 1, wherein determining, according to the speckled pixels of the thumbnail image, the speckled pixels of the to-be-processed image comprises:
reading a first image block of the to-be-processed image from an external memory into a memory at one time;
selecting a second image block corresponding to the first image block from the thumbnail image, the second image block including pixels of the thumbnail image obtained by down-sampling or sampling the first image block; and
determining, according to the second image block, the speckled pixels of the first image block in the memory.

11. The method according to claim 1, wherein the thumbnail image is a down-sampled image or a sampled image of the to-be-processed image.

12. An image processing system, comprising:
a memory for storing programs; and
a processor for executing the programs stored in the memory, wherein when the programs are executed, the processor is configured to execute:
acquiring a thumbnail image of a to-be-processed image;
performing a speckle detection on the thumbnail image to obtain speckled pixels of the thumbnail image; and
determining, according to the speckled pixels of the thumbnail image, speckled pixels of the to-be-processed image.

13. The system according to claim 12, wherein for determining, according to the speckled pixels of the thumbnail image, the speckled pixels of the to-be-processed image, the processor is configured to execute:
selecting, according to the speckled pixels of the thumbnail image, a target pixel set from the to-be-processed image, pixels of the target pixel set being pixels having a corresponding relationship with the speckled pixels of the thumbnail image; and
determining the pixels of the target pixel set as the speckled pixels of the to-be-processed image.

14. The system according to claim 12, wherein for determining, according to the speckled pixel of the thumbnail image, the speckled pixels of the to-be-processed image, the processor is configured to execute:
selecting reference pixels of first pixels from part of pixels of the to-be-processed image, a first pixel being any one of the remaining pixels of the to-be-processed image except the target pixel set, the pixels of the target pixel set being pixels having a corresponding relationship with the speckled pixels of the thumbnail image, the reference pixels are one or more pixels of part of the pixels that are closest to the first pixel; and
determining, if the first pixels and the reference pixels of the first pixel satisfy a first preset condition, the first pixel as the speckled pixels of the to-be-processed image.

15. The system according to claim 14, wherein for determining, if the first pixels and the reference pixels of the first pixels satisfy the first preset condition, the first pixels as the speckled pixels of the to-be-processed image, the processor is configured to execute:
determining, if the reference pixels of the first pixels include pixels belonging to the target pixel set, the first pixels as the speckled pixels of the to-be-processed image; and
determining, if the reference pixels of the first pixels does not include the pixels belonging to the target pixel set, differences between pixel values of the first pixels and pixel values of the reference pixels of the first pixels; determining, if the differences between the pixel value of the first pixel and pixel values of the reference pixels of the first pixel satisfy a second preset condition, the first pixels as speckled pixels of the to-be-processed image.

16. The system according to claim 15, wherein for determining, if the differences between the pixel values of the first pixels and the pixel values of the reference pixels of the first pixel satisfy the second preset condition, the first pixels as the speckled pixels of the to-be-processed image, the processor is configured to execute:
determining, if the differences between the pixel values of the first pixel and a pixel value of any one of the reference pixels of the first pixel are greater than a preset threshold, the first pixels as the speckled pixels of the to-be-processed image.

17. A non-transitory computer-readable storage medium, containing program instructions for a computer, when the program instructions being executed, to perform a method, the method comprising:
acquiring a thumbnail image of a to-be-processed image;
performing a speckle detection on the thumbnail image to obtain speckled pixels of the thumbnail image; and
determining, according to the speckled pixels of the thumbnail image, speckled pixels of the to-be-processed image.

18. The storage medium according to claim 17, wherein for determining, according to the speckled pixels of the thumbnail image, the speckled pixels of the to-be-processed image, the computer is configured to perform:
selecting adjacent pixels of each pixel in at least one pixel in the target pixel set from the to-be-processed image, the pixels in the target pixel set being pixels having a corresponding relationship with the speckled pixels of the thumbnail image; and
determining the adjacent pixels of each pixel as speckled pixels of the to-be-processed image.

19. The storage medium according to claim 17, wherein a size of an image data of the thumbnail image is smaller than a capacity of a memory, and before a speckle detection on the thumbnail image is performed, the method comprises:
reading the thumbnail image into the memory;
performing a speckle detection on the thumbnail image including:
performing the speckle detection on the thumbnail image in the memory.

20. The storage medium according to claim 17, wherein for determining, according to the speckled pixels of the thumbnail image, the speckled pixels of the to-be-processed image, the computer is configured to perform:
reading a first image block of the to-be-processed image from an external memory into a memory at one time;
selecting a second image block corresponding to the first image block from the thumbnail image, the second image block including pixels of the thumbnail image obtained by down-sampling or sampling the first image block; and
determining, according to the second image block, the speckled pixels of the first image block in the memory.
